(19) United States
(12) Patent Application Publication
(10) Pub. No.: US 2023/0421934 A1
(43) Pub. Date: Dec. 28, 2023

(54) COMMUNICATION CONTROL DEVICE, COMMUNICATION CONTROL SYSTEM, COMMUNICATION CONTROL METHOD AND COMMUNICATION CONTROL PROGRAM

(71) Applicant: NIPPON TELEGRAPH AND TELEPHONE CORPORATION, Tokyo (JP)

(72) Inventors: Takamitsu TOCHINO, Musashino-shi, Tokyo (JP); Hirotaka UJIKAWA, Musashino-shi, Tokyo (JP); Yoshihito SAKAI, Musashino-shi, Tokyo (JP)

(73) Assignee: NIPPON TELEGRAPH AND TELEPHONE CORPORATION, Tokyo (JP)

(21) Appl. No.: 18/037,072

(22) PCT Filed: Nov. 25, 2020
(86) PCT No.: PCT/JP2020/043826

§ 371 Date: May 15, 2023

(51) Int. Cl. H04Q 11/00; H04B 10/032

(52) U.S. Cl. CPC H04Q 11/0067; H04B 10/032; H04Q 2011/0081

(57) ABSTRACT

Provided are a communication control device, a communication control system, a communication control method, and a communication control program that make it difficult to reduce band utilization efficiency. In an OLT server 9b that is a communication control device, a transmission time storage unit 12 stores a transmission time of an optical signal between each ONU 3 and OLT 4. An optical transmission control unit 13 generates control information for controlling transmission start and transmission end of optical signals in each ONU 3. A failure detection suppression unit 15 calculates a first time at which the reception of the optical signal from an ONU 3p ends using control information and a transmission time. The failure detection suppression unit 15 calculates a second time at which synchronization processing ends after the reception of the optical signal from an ONU 3q that transmits the optical signal next after the ONU 3p is started using the synchronization time until the synchronization processing acquired by a synchronization time acquisition unit 14 ends. The failure detection suppression unit 15 causes the failure detection unit 11 that detects a link failure in an OLT 4 to suppress detection of a link failure from the first time to the second time.

### TECHNICAL FIELD

The present disclosure relates to a communication control device, a communication control system, a communication control method, and a communication control program.

### BACKGROUND ART

Non Patent Literature 1 and Non Patent Literature 2 disclose examples of communication systems. In a communication system, a passive optical network (PON) including a plurality of optical network units (ONUs) and optical line terminals (OLTs) is constructed. In the communication system, a time division multiple access (TDMA) technology is used for uplink communication from the ONU to the OLT. The OLT of Non Patent Literature 1 includes an OLT server, a network interface card (NIC), and a transceiver (TRx).

### CITATION LIST

### Non Patent Literature

Non Patent Literature 1: T. Tochino et al., “Redesigned TDM-PON System Architecture Based on Point-to-Point Ethernet Transmission and Software Processing with General-purpose Hardware,” Journal of Lightwave Technology, 2020.
Non Patent Literature 2: IEEE Standard for Ethernet, SECTION FIVE, IEEE 802.3, 2015.

### SUMMARY OF INVENTION

### Technical Problem

However, in the communication system of Non Patent Literature 1, link fault signaling (LFS) of Ethernet operates in an NIC of an OLT between frames from an ONU. At this time, since transmission of a Layer-2 (L2) frame is not possible, the utilization efficiency of the band decreases.

The present disclosure relates to solving such problems. The present disclosure provides a communication control device, a communication control system, a communication control method, and a communication control program that make it difficult for the band utilization efficiency to become lowered.

### Solution to Problem

A communication control device according to the present disclosure includes a transmission time storage unit that stores a transmission time of an optical signal with each of a plurality of ONUs, a synchronization time acquisition unit that acquires a synchronization time from reception of an optical signal of each of the plurality of ONUs to end of synchronization processing, an optical transmission control unit that generates control information that is transmitted to the plurality of ONUs and controls transmission start and transmission end of an optical signal in each of the plurality of ONUs, and a failure detection suppression unit that calculates a first time at which reception of an optical signal from a first ONU among the plurality of ONUs ends using control information generated by the optical transmission control unit for the first ONU and a transmission time with the first ONU stored in the transmission time storage unit, calculates a second time at which synchronization processing ends after reception of an optical signal from a second ONU that transmits an optical signal next after the first ONU among the plurality of ONUs is started using the synchronization time acquired by the synchronization time acquisition unit, and causes a failure detection unit that detects a link failure with respect to the plurality of ONUs to suppress detection of a link failure during a period from the first time to the second time.

A communication control system according to the present disclosure includes the communication control device and a failure detection unit that detects a link failure between the plurality of ONUs.

A communication control method according to the present disclosure is a method in which a communication control device executes a transmission time storage step of storing a transmission time of an optical signal with each of a plurality of ONUs, a synchronization time acquisition step of acquiring a synchronization time from reception of an optical signal of each of the plurality of ONUs to end of synchronization processing, an optical transmission control step of generating control information that is transmitted to the plurality of ONUs and controls transmission start and transmission end of an optical signal in each of the plurality of ONUs, a first calculation step of calculating a first time at which reception of an optical signal from a first ONU among the plurality of ONUs ends using control information generated in the optical transmission control step for the first ONU and a transmission time with the first ONU stored in the transmission time storage step, a second calculation step of calculating a second time at which synchronization processing ends after reception of an optical signal from a second ONU of the plurality of ONUs that transmits an optical signal next after the first ONU is started using the synchronization time acquired in the synchronization time acquisition step, and a failure detection suppression step of causing a failure detection unit that detects a link failure with respect to the plurality of ONUs to suppress detection of a link failure by designating a period from the first time calculated in the first calculation step to the second time calculated in the second calculation step.

A communication control method according to the present disclosure is a method in which a communication control device executes a transmission time storage step of storing a transmission time of an optical signal with each of a plurality of ONUs, a synchronization time acquisition step of acquiring a synchronization time from reception of an optical signal of each of the plurality of ONUs to end of synchronization processing, an optical transmission control step of generating control information that is transmitted to the plurality of ONUs and controls transmission start and transmission end of an optical signal in each of the plurality of ONUs, a first calculation step of calculating a first time at which reception of an optical signal from a first ONU among the plurality of ONUs ends using control information generated in the optical transmission control step for the first ONU and a transmission time with the first ONU stored in the transmission time storage step; a second calculation step of calculating a second time at which synchronization processing ends after reception of an optical signal from a second ONU of the plurality of ONUs that transmits an optical signal next after the first ONU is started using the synchronization time acquired in the synchronization time acquisition step, a suppression start step of causing a failure detection unit that detects a link failure with respect to the plurality of ONUs to start suppression of detection of a link failure from the first time calculated in the first calculation step, and a suppression end step of causing the failure detection unit to end suppression of detection of a link failure at the second time calculated in the second calculation step.

A communication control program according to the present disclosure causes a communication control device to execute a transmission time storage step of storing a transmission time of an optical signal with each of a plurality of ONUs, a synchronization time acquisition step of acquiring a synchronization time from reception of an optical signal of each of the plurality of ONUs to end of synchronization processing, an optical transmission control step of generating control information that is transmitted to the plurality of ONUs and controls transmission start and transmission end of an optical signal in each of the plurality of ONUs, a first calculation step of calculating a first time at which reception of an optical signal from a first ONU among the plurality of ONUs ends using control information generated in the optical transmission control step for the first ONU and a transmission time with the first ONU stored in the transmission time storage step; a second calculation step of calculating a second time at which synchronization processing ends after reception of an optical signal from a second ONU of the plurality of ONUs that transmits an optical signal next after the first ONU is started using the synchronization time acquired in the synchronization time acquisition step, and a failure detection suppression step of causing a failure detection unit that detects a link failure with respect to the plurality of ONUs to suppress detection of a link failure by designating a period from the first time calculated in the first calculation step to the second time calculated in the second calculation step.

A communication control program according to the present disclosure causes a communication control device to execute a transmission time storage step of storing a transmission time of an optical signal with each of a plurality of ONUs, a synchronization time acquisition step of acquiring a synchronization time from reception of an optical signal of each of the plurality of ONUs to end of synchronization processing, an optical transmission control step of generating control information that is transmitted to the plurality of ONUs and controls transmission start and transmission end of an optical signal in each of the plurality of ONUs, a first calculation step of calculating a first time at which reception of an optical signal from a first ONU among the plurality of ONUs ends using control information generated in the optical transmission control step for the first ONU and a transmission time with the first ONU stored in the transmission time storage step, a second calculation step of calculating a second time at which synchronization processing ends after reception of an optical signal from a second ONU of the plurality of ONUs that transmits an optical signal next after the first ONU is started using the synchronization time acquired in the synchronization time acquisition step, a suppression start step of causing a failure detection unit that detects a link failure with respect to the plurality of ONUs to start suppression of detection of a link failure from the first time calculated in the first calculation step, and a suppression end step of causing the failure detection unit to end suppression of detection of a link failure at the second time calculated in the second calculation step.

### Advantageous Effects of Invention

According to the communication control device, the communication control system, the communication control method, or the communication control program according to the present disclosure, the band utilization efficiency is less likely to decrease.

### BRIEF DESCRIPTION OF DRAWINGS

FIG. 1 is a configuration diagram of a communication system according to Embodiment 1.

FIG. 2 is a diagram illustrating an example of a configuration of an OLT according to Embodiment 1.

FIG. 3 is a diagram illustrating an example of communication control in the communication system according to Embodiment 1.

FIG. 4 is a flowchart illustrating an example of an operation of the OLT server according to Embodiment 1.

FIG. 5 is a flowchart illustrating an example of an operation of the OLT server according to Embodiment 2.

### DESCRIPTION OF EMBODIMENTS

Embodiments of the present disclosure will be described with reference to the accompanying drawings. In each figure, the same or corresponding parts are denoted by the same reference numerals, and redundant description is appropriately simplified or omitted. Note that the present disclosure is not limited to the following embodiments, and it is possible to freely combine the individual embodiments, modify any components of the individual embodiments, or omit any component of the individual embodiments within the scope not departing from the gist of the present disclosure.

### Embodiment 1

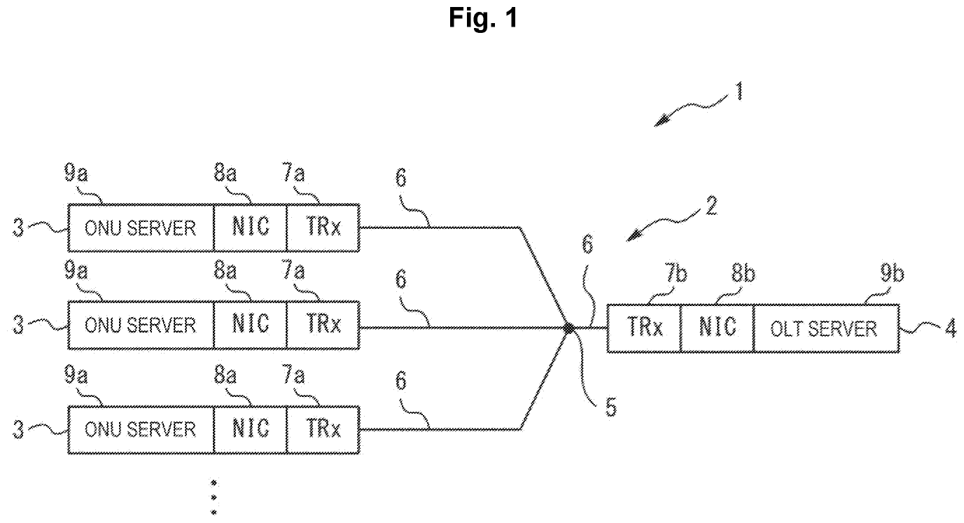

FIG. 1 is a configuration diagram illustrating a communication system 1 according to Embodiment 1.

In the communication system 1, a PON 2 is constructed. The PON 2 includes a plurality of ONUs 3, an OLT 4, and an optical branching unit 5. Each ONU 3 is connected to the optical branching unit 5 by an optical communication line 6. The optical communication line 6 is, for example, an optical fiber cable. The OLT 4 is connected to the optical branching unit 5 by an optical communication line 6. The optical branching unit 5 is an optical passive component such as an optical coupler or an optical splitter. Each of the ONUs 3 and the OLT 4 communicates an optical signal through the optical communication line 6 and the optical branching unit 5. In the communication system 1, a TDMA technology is used for uplink communication from the ONU 3 to the OLT 4.

Each ONU 3 is disposed at a base, a house, or the like of a subscriber who receives provision of a communication service in the communication system 1. Each ONU 3 is a device that converts an electrical signal from a network or the like used by a subscriber into an optical signal, and transmits an optical signal to the OLT 4, and the like in uplink communication of the PON 2. The network used by the subscriber is, for example, a local area network (LAN). Each ONU 3 includes a TRx 7a, an NIC 8a, and an ONU server 9a. The TRx 7a is a device having a function of mutually converting between an electrical signal and an optical signal. The NIC 8a is a device having a function of performing communication processing according to a standard such as Ethernet (registered trademark). The ONU server 9a is a device having a function of controlling communication or the like with the OLT 4 by the NIC 8a and the TRx 7a.

The OLT 4 is disposed at a base or the like of a company that provides a communication service in the communication system 1. The OLT 4 is a device that receives an optical signal from each ONU 3, and converts the optical signal into an electrical signal to a high-order network, and the like in uplink communication of the PON 2. The high-order network is, for example, the Internet. The OLT 4 includes a TRx 7b, an NIC 8b, and an OLT server 9b. The TRx 7b is a device having a function of mutually converting between an electrical signal and an optical signal. The NIC 8b is a device having a function of performing communication processing according to a standard such as Ethernet. The OLT server 9b is a device having a function of controlling communication and the like between the NIC 8b and each ONU 3 by the TRx 7b. The OLT server 9b is an example of a communication control device. The OLT 4 is an example of a communication control system.

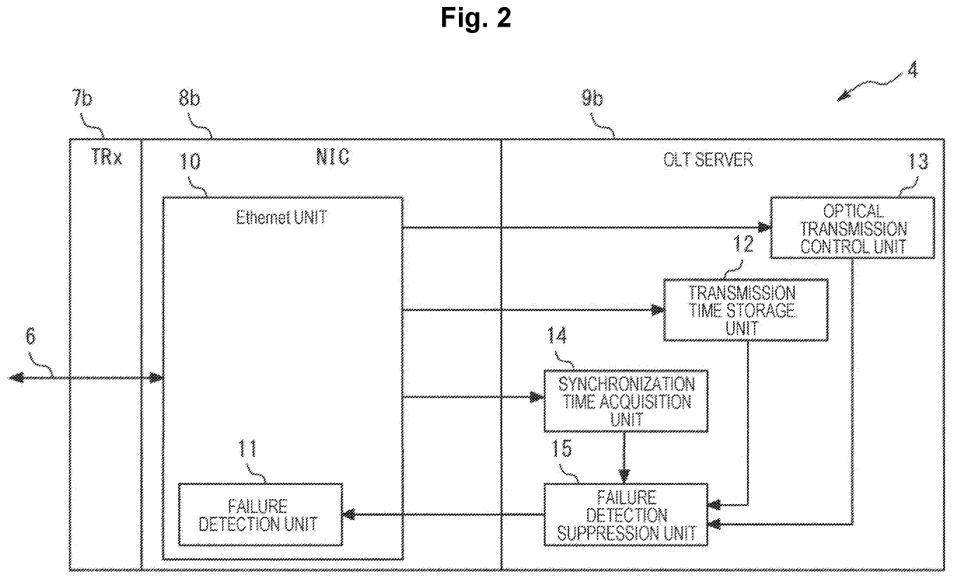

FIG. 2 is a diagram illustrating an example of a configuration of the OLT 4 according to Embodiment 1.

The NIC 8b includes an Ethernet unit 10. The Ethernet unit 10 is a unit that performs processing of Ethernet frames and the like. The Ethernet unit 10 is, for example, an Ethernet controller in the NIC 8b. The Ethernet unit 10 includes a failure detection unit 11. The failure detection unit 11 is a unit that detects a link failure with respect to each ONU 3. In this example, the failure detection unit 11 is a unit that performs processing of the LFS defined in, for example, Ethernet. The link failure detected by the failure detection unit 11 includes, for example, a situation of collision of optical signals simultaneously received from a plurality of ONUs 3. In addition, the link failure detected by the failure detection unit 11 includes, for example, a situation where optical signals are not received from any ONU 3.

The OLT server 9b includes a transmission time storage unit 12, an optical transmission control unit 13, a synchronization time acquisition unit 14, and a failure detection suppression unit 15. The functions of the optical transmission control unit 13, the transmission time storage unit 12, the synchronization time acquisition unit 14, and the failure detection suppression unit 15 of the OLT server 9b are executed based on, for example, a communication control program installed in the OLT server 9b. The communication control program installed in the OLT server 9b may be recorded in, for example, a recording medium.

The transmission time storage unit 12 is a unit that stores information. The transmission time storage unit 12 stores a transmission time of an optical signal between the OLT 4 and each ONU 3. The transmission time with each ONU 3 is measured, for example, when the ONU 3 is connected. The transmission time is, for example, a round trip time (RTT) acquired in the Ethernet. The measured transmission time is stored in the transmission time storage unit 12. The transmission time with each ONU 3 may be updated each time communication with the ONU 3 is performed.

An optical transmission control unit 13 is a part for generating control information for controlling transmission start and transmission end of optical signals in each ONU 3. The control information is transmitted to each ONU 3 through the NIC 8b and the TRx 7b, the optical communication line 6, the optical branching unit 5, and the like. The control information is, for example, a GATE frame of the Ethernet. The control information transmitted to each ONU 3 includes, for example, information such as whether or not to transmit an optical signal from the ONU 3, a transmission start time of the optical signal, and a transmission duration of the optical signal. The control information may include information on the transmission time stored in the transmission time storage unit 12. The optical transmission control unit 13 generates control information based on, for example, transmission request information received from each ONU 3. The transmission request information is, for example, a REPORT frame of the Ethernet.

The synchronization time acquisition unit 14 is a unit that acquires a synchronization time. The synchronization time is a time from when the optical signal of each ONU 3 is received to when the synchronization processing ends. The synchronization time may be a time starting point from a time when the output of the received optical signal is stable. The starting point of the synchronization time is, for example, a time point at which the output of a LOS pin of the TRx 7b is switched. The end time point of the synchronization time is, for example, a time point when the NIC 8b detects Ethernet synchronization. Here, the NIC 8b links down by the LFS when the Ethernet synchronization is lost in a link failure situation in which an optical signal is not received from any ONU 3, for example. Thereafter, the NIC 8b links up when the Ethernet is synchronized. The synchronization time acquisition unit 14 acquires the synchronization time with the timing of link-up as an end point, for example. The synchronization time acquisition unit 14 acquires the synchronization time by calculation, for example. Alternatively, the synchronization time acquisition unit 14 may acquire a value of the synchronization time used to control communication based on the measurement value of the past synchronization time.

The failure detection suppression unit 15 is a unit that suppresses detection of a link failure by the failure detection unit 11. The failure detection suppression unit 15 designates a period from a first time to a second time, for example, and outputs a control command for suppressing detection of a link failure to the failure detection unit 11. The failure detection unit 11 has a function of calculating the first time and the second time.

Next, an example of a hardware configuration of a device of the communication system 1 including the OLT 4, each ONU 3, and the like will be described. The device of the communication system 1 includes, for example, the OLT server 9b, the NIC 8b, and the TRx 7b, and the ONU server 9a, the NIC 8a, and the TRx 7a. The device of the communication system 1 includes a processing circuit including, for example, a processor and a memory as hardware. The processor is, for example, a CPU, an arithmetic device, a microprocessor, a microcomputer, or the like. The memory corresponds to, for example, a nonvolatile or volatile semiconductor memory such as RAM, ROM, a flash memory, EPROM, or EEPROM, or a magnetic disk, a flexible disc, an optical disc, a compact disc, a mini disc, or DVD. The memory stores, for example, a program as software or firmware. Then, the device of the communication system 1 performs preset processing by the processor executing a program or the like stored in the memory, and realizes each function as a result of cooperation between hardware and software. Each function of the device of the communication system 1 may be realized by a processing circuit. Alternatively, some or all of the functions of the device of the communication system 1 may be collectively implemented by a processing circuit. In addition, the processing circuit may be realized by, for example, a single circuit, a composite circuit, a programmed processor, a parallel programmed processor, ASIC, or FPGA, or a combination thereof.

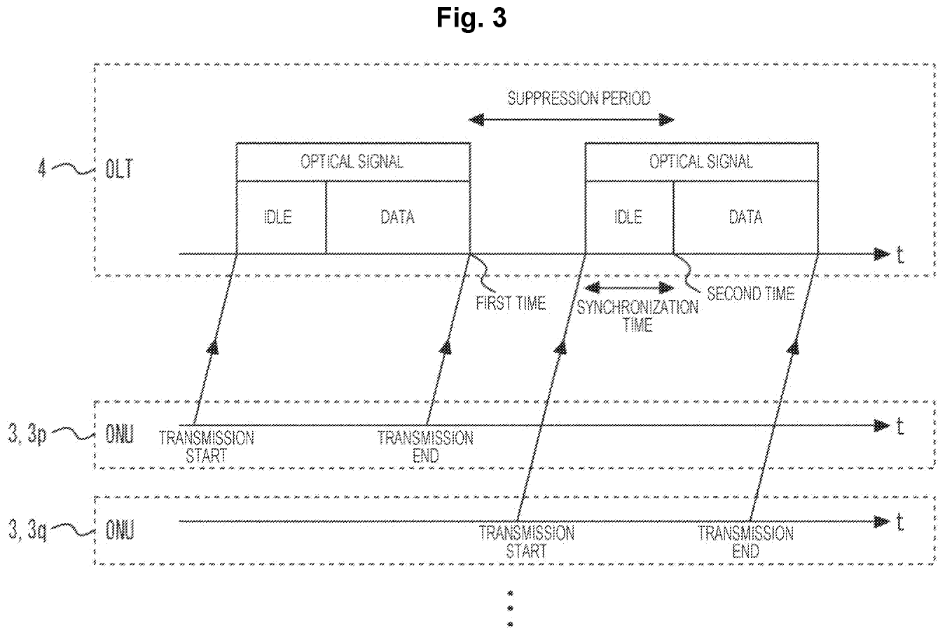

Next, an example of suppression of detection of a link failure will be described with reference to FIG. 3.

FIG. 3 is a diagram illustrating an example of communication control in the communication system 1 according to Embodiment 1.

In FIG. 3, a horizontal axis represents time.

When each ONU 3 is connected to the PON 2, the transmission time is measured by, for example, reciprocating an optical signal between the ONU 3 and the OLT 4. The OLT server 9b acquires information represented by the optical signal from each ONU 3 through the TRx 7b and the NIC 8b. The transmission time storage unit 12 of the OLT server 9b stores the transmission time measured here.

In this example, each ONU 3 connected to the PON 2 transmits an optical signal to the OLT 4 in a burst mode. Each ONU 3 transmits transmission request information to the OLT 4 based on the capacity of data received from the network or the like used by the subscriber.

The optical transmission control unit 13 of the OLT server 9b allocates a band to each ONU 3 based on transmission request information received from each ONU 3. The optical transmission control unit 13 generates control information to be transmitted to each ONU 3 based on the allocated band. The optical transmission control unit 13 transmits control information to each ONU 3 through the NIC 8b and the TRx 7b.

For example, when the optical transmission control unit 13 generates control information, the failure detection suppression unit 15 calculates the first time and the second time. Here, the first time and the second time are calculated for each set of the ONU 3 that transmits the optical signal first and the ONU 3 that transmits the optical signal next, among the plurality of ONUs 3 that sequentially transmit the optical signal. The ONU 3 that first transmits an optical signal is an example of a first ONU. The ONU 3 that transmits an optical signal next is an example of a second ONU. In this example, the ONU 3q transmits an optical signal next after the ONU 3p.

The failure detection suppression unit 15 calculates the first time using the control information and the transmission time. The failure detection suppression unit 15 calculates the time at which the OLT 4 ends the reception of the optical signal from the ONU 3p using, for example, the transmission start time and the transmission duration in the control information for the ONU 3p and the transmission time with the ONU 3p. The failure detection suppression unit 15 sets the time calculated here as the first time for the set of the ONU 3p and the ONU 3q.

The failure detection suppression unit 15 calculates the first time using the synchronization time. The failure detection suppression unit 15 calculates a time at which the synchronization processing ends after the reception of the optical signal from the ONU 3q is started using, for example, the transmission start time in the control information for the ONU 3q, the transmission time with the ONU 3q, and the synchronization time acquired by the synchronization time acquisition unit 14. The failure detection suppression unit 15 sets the time calculated here as the second time for the set of the ONU 3p and the ONU 3q.

The failure detection suppression unit 15 outputs, to the failure detection unit 11, a control command for suppressing detection of a link failure by designating the calculated period from the first time to the second time for a set of the ONU 3p and the ONU 3q. The failure detection suppression unit 15 similarly outputs a control command to the failure detection unit 11 for another set of ONUs 3.

Thereafter, the ONU 3p starts transmitting the optical signal from the transmission start time in a case where the optical signal can be transmitted in the control information received from the OLT 4. The ONU 3p ends the transmission of the optical signal when the transmission duration of the control information has elapsed.

The OLT 4 ends the reception of the optical signal from the ONU 3p after the transmission time is delayed from the time when the ONU 3p ends the transmission of the optical signal. Since the time at this time is the first time, the failure detection suppression unit 15 starts suppression of detection of a link failure from the time.

At this time, the OLT 4 has not received an optical signal from any ONU 3, but since it is within the period designated in the control command received from the failure detection suppression unit 15, the failure detection unit 11 does not detect a link failure.

Thereafter, the ONU 3q starts transmitting the optical signal from the transmission start time in a case where the optical signal can be transmitted in the control information received from the OLT 4. The ONU 3q may transmit an idle signal until the synchronization time included in the control information elapses. At this time, the ONU 3q starts transmitting a data signal after the synchronization time has elapsed. Here, the data signal is an optical signal including data from a network connected to the ONU 3q to a network connected to the OLT 4.

The OLT 4 starts receiving the optical signal from the ONU 3q after a transmission time is delayed from the time when the ONU 3q starts transmitting the optical signal. Thereafter, after the synchronization time has elapsed, the OLT 4 starts receiving a data signal from the ONU 3q. Since the time at this time is the second time, the failure detection suppression unit 15 ends the suppression of the detection of the link failure at this time.

At this time, since the period designated in the control command received from the failure detection suppression unit 15 has ended, the failure detection unit 11 detects a link failure when an optical signal from the ONU 3q is interrupted, when a collision of optical signals occurs in the OLT 4, or the like.

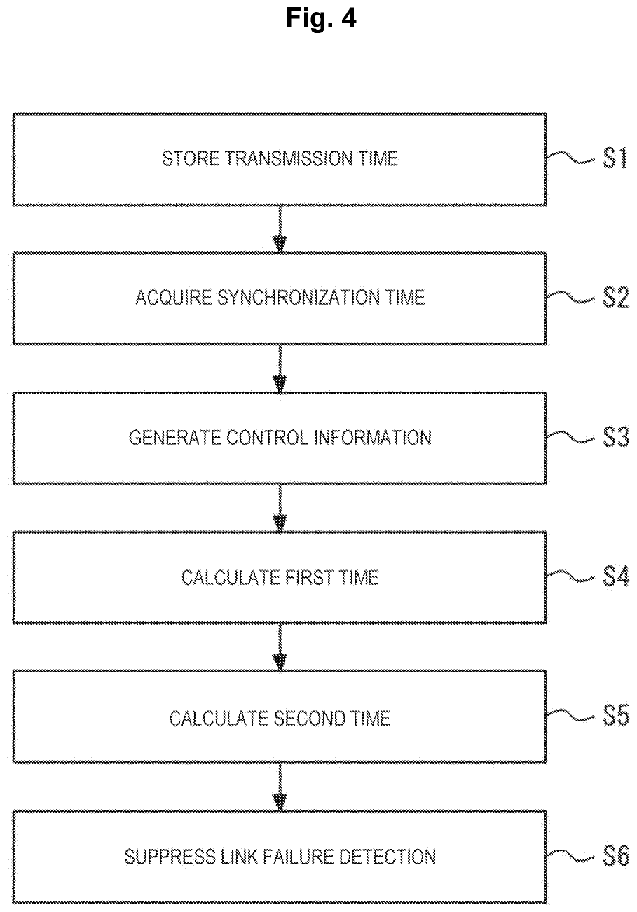

Next, an example of the operation of the OLT server 9b will be described with reference to FIG. 4.

FIG. 4 is a flowchart illustrating an example of an operation of the OLT server 9b according to Embodiment 1.

In step S1, the transmission time storage unit 12 stores the transmission time measured with each ONU 3.

Thereafter, in step S2, the synchronization time acquisition unit 14 acquires the synchronization time in the OLT 4. Thereafter, in step S3, the optical transmission control unit 13 generates control information for each ONU 3. The generated control information is transmitted to each ONU 3. Thereafter, in step S4, the failure detection suppression unit 15 calculates the first time. Thereafter, in step S5, the failure detection suppression unit 15 calculates the second time. Thereafter, in step S6, the failure detection suppression unit 15 causes the failure detection unit 11 to suppress the detection of the link failure by outputting a control command designating a period from the first time to the second time. Thereafter, the failure detection unit 11 suppresses detection of a link failure during the designated period.

Here, step S2 may be executed before step S1. Steps S1 and S2 may be appropriately omitted after being executed once. Step S5 may be executed before step S4. In addition, the execution order of each step may be appropriately changed without departing from the gist of the present disclosure. Furthermore, each step may be executed in parallel as appropriate without departing from the spirit of the present disclosure.

As described above, the OLT 4 according to Embodiment 1 includes the NIC 8b having the failure detection unit 11 and the OLT server 9b which is an example of the communication control device. The failure detection unit 11 detects a link failure with respect to the ONU 3 connected to the OLT 4. The OLT server 9b includes the transmission time storage unit 12, the synchronization time acquisition unit 14, the optical transmission control unit 13, and the failure detection suppression unit 15. The transmission time storage unit 12 stores a transmission time of an optical signal between each ONU 3 and the OLT 4. The synchronization time acquisition unit 14 acquires a synchronization time from the reception of the optical signal of each ONU 3 to the end of the synchronization processing. The optical transmission control unit 13 generates control information to be transmitted to a plurality of ONUs 3. The control information is information for controlling transmission start and transmission end of optical signals in each ONU 3. In the plurality of ONUs 3, the ONU 3q transmits an optical signal next after the ONU 3p. A failure detection suppression unit 15 calculates a first time at which the reception of the optical signal from an ONU 3p ends. The first time is calculated using the control information generated by the optical transmission control unit 13 for the ONU 3p and the transmission time with the ONU 3p stored in the transmission time storage unit 12. The failure detection suppression unit 15 calculates the second time at which the synchronization processing ends after the reception of the optical signal from the ONU 3q is started. The second time is calculated using the synchronization time acquired by the synchronization time acquisition unit 14. The failure detection suppression unit 15 causes the failure detection unit 11 to suppress the detection of the link failure from the first time to the second time.

In addition, the failure detection suppression unit 15 causes the failure detection unit 11 to suppress the detection of the link failure by outputting a control command designating a period from the first time to the second time.

In addition, the communication control method according to Embodiment 1 is a method in which the OLT server 9b executes a transmission time storage step, a synchronization time acquisition step, an optical transmission control step, a first calculation step, a second calculation step, and a failure detection suppression step. The transmission time storage step is a step of storing a transmission time for each ONU 3. The synchronization time acquisition step is a step of acquiring a synchronization time in the OLT 4. The optical transmission control step is a step of generating control information to be transmitted to a plurality of ONUs 3. The first calculation step is a step of calculating the first time for the ONU 3p. The second calculation step is a step of calculating the second time for the ONU 3q. The failure detection suppression step is a step of designating a period from the first time calculated in the first calculation step to the second time calculated in the second calculation step and causing the failure detection unit 11 to suppress the detection of the link failure.

In addition, the communication control program according to Embodiment 1 is a program that causes the OLT server 9b to execute the transmission time storage step, the synchronization time acquisition step, the optical transmission control step, the first calculation step, the second calculation step, and the failure detection suppression step.

With such a configuration, detection of a link failure is suppressed during a frame in which a data signal is transmitted in a burst mode or the like. Therefore, even if the OLT 4 does not receive the optical signal between these frames, the link failure is not detected. Therefore, transmission of the L2 frame is not suppressed, and thus the utilization efficiency of the band is less likely to decrease. In addition, the detection of the link failure is effective while the frame including the data signal is transmitted. Therefore, in a case where a link failure actually occurs, processing corresponding to the link failure is appropriately performed in the communication system 1.

### Embodiment 2

In Embodiment 2, points different from the example disclosed in Embodiment 1 will be described in particular detail. Any feature of the example disclosed in Embodiment 1 may be adopted as a feature not described in Embodiment 2.

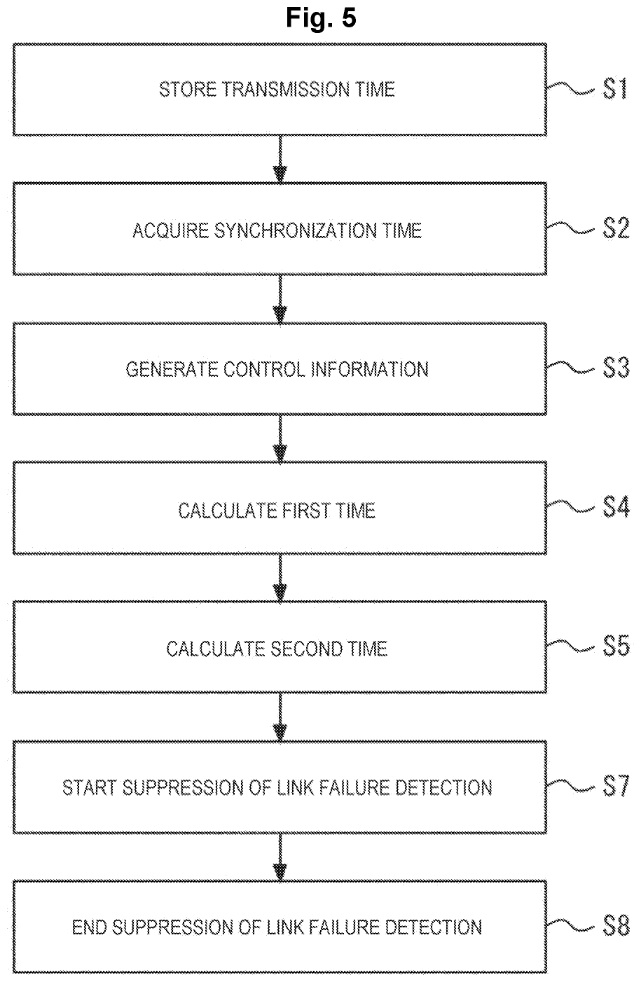

FIG. 5 is a flowchart illustrating an example of an operation of the OLT server 9b according to Embodiment 2.

The OLT server 9b according to Embodiment 2 operates similarly to the OLT server 9b according to Embodiment 1 in steps S1 to S5. After the second time is calculated in step S5, the operation of the OLT server 9b according to Embodiment 2 proceeds to step S7. In step S7, the failure detection suppression unit 15 causes the failure detection unit 11 to start the suppression of the detection of the link failure from the first time by outputting the control command designating the first time. Thereafter, the failure detection unit 11 starts suppressing the detection of the link failure from the first time. In step S8, the failure detection suppression unit 15 causes the failure detection unit 11 to end the suppression of the detection of the link failure at the second time by outputting the control command designating the second time. Thereafter, the failure detection unit 11 ends the suppression of the detection of the link failure at the second time.

Here, step S5 may be executed after step S7. At this time, step S2 may be executed after step S7. For example, at least one of step S2 or step S5 may be executed when the output of the optical signal from the ONU 3q is stable. In this case, the failure detection suppression unit 15 may not use the transmission time and the control information for the calculation for the second time. In addition, the execution order of each step may be appropriately changed without departing from the gist of the present disclosure. Furthermore, each step may be executed in parallel as appropriate without departing from the spirit of the present disclosure.

As described above, in the OLT 4 according to Embodiment 2, the failure detection suppression unit 15 causes the failure detection unit 11 to start the suppression of the detection of the link failure by outputting the control command designating the first time. The failure detection suppression unit 15 causes the failure detection unit 11 to end the suppression of the detection of the link failure by outputting the control command designating the second time.

In addition, the communication control method according to Embodiment 2 is a method in which the OLT server 9b executes a transmission time storage step, a synchronization time acquisition step, an optical transmission control step, a first calculation step, a second calculation step, a suppression start step, and a suppression end step. The suppression start step is a step of causing the failure detection unit 11 to start suppression of detection of a link failure from the first time calculated in the first calculation step. The suppression end step is a step of causing the failure detection unit 11 to end suppression of detection of a link failure from the second time calculated in the second calculation step.

In addition, the communication control program according to Embodiment 2 is a program that causes the OLT server 9b to execute a transmission time storage step, a synchronization time acquisition step, an optical transmission control step, a first calculation step, a second calculation step, a suppression start step, and a suppression end step.

With such a configuration, detection of a link failure is suppressed during a frame in which a data signal is transmitted in a burst mode or the like. Therefore, even if the OLT 4 does not receive the optical signal between these frames, the link failure is not detected. Therefore, transmission of the L2 frame is not suppressed, and thus the utilization efficiency of the band is less likely to decrease. In addition, the detection of the link failure is effective while the frame including the data signal is transmitted. Therefore, in a case where a link failure actually occurs, processing corresponding to the link failure is appropriately performed in the communication system 1.

### INDUSTRIAL APPLICABILITY

The communication control system according to the present disclosure can be applied to a communication system. The communication control device according to the present disclosure can be applied to the communication control system. The communication control method according to the present disclosure can be applied to a communication system including the communication control device. The communication control program according to the present disclosure can be applied to the communication control device.

### REFERENCE SIGNS LIST

1 Communication system
2 PON
3 ONU
4 OLT
5 Optical branching unit
6 Optical communication line
7a, 7b TRx
8a, 8b NIC
9a ONU server
9b OLT server
10 Ethernet unit
11 Failure detection unit
12 Transmission time storage unit
13 Optical transmission control unit
14 Synchronization time acquisition unit
15 Failure detection suppression unit

1. A communication control device comprising:
a processor; and
a storage medium having computer program instructions stored thereon, when executed by the processor, perform to:
stores a transmission time of an optical signal with each of a plurality of ONUs;
acquires a synchronization time from reception of an optical signal of each of the plurality of ONUs to end of synchronization processing;
generates control information that is transmitted to the plurality of ONUs and controls transmission start and transmission end of an optical signal in each of the plurality of ONUs; and
calculates a first time at which reception of an optical signal from a first ONU among the plurality of ONUs ends using control information for the first ONU and a transmission time with the first ONU stored in the transmission time storage unit, calculates a second time at which synchronization processing ends after reception of an optical signal from a second ONU that transmits an optical signal next after the first ONU among the plurality of ONUs is started using the synchronization time, and causes a failure detection unit that detects a link failure with respect to the plurality of ONUs to suppress detection of a link failure during a period from the first time to the second time.

2. The communication control device according to claim 1,
wherein the computer program instructions further perform to
suppress detection of a link failure by outputting a control command designating a period from the first time to the second time.

3. The communication control device according to claim 1,
wherein the computer program instructions further perform to start suppression of detection of a link failure by outputting a control command designating the first time and causes to end the suppression of detection of a link failure by outputting a control command designating the second time.

4. A communication control system comprising:
the communication control device according to claim 1; and
a failure detection unit that detects a link failure with respect to the plurality of ONUs.

5. A communication control method in which a communication control device executes
a transmission time storage step of storing a transmission time of an optical signal with each of a plurality of ONUs,
a synchronization time acquisition step of acquiring a synchronization time from reception of an optical signal of each of the plurality of ONUs to end of synchronization processing,
an optical transmission control step of generating control information that is transmitted to the plurality of ONUs and controls transmission start and transmission end of an optical signal in each of the plurality of ONUs,
a first calculation step of calculating a first time at which reception of an optical signal from a first ONU among the plurality of ONUs ends using control information generated in the optical transmission control step for the first ONU and a transmission time with the first ONU stored in the transmission time storage step,
a second calculation step of calculating a second time at which synchronization processing ends after reception of an optical signal from a second ONU of the plurality of ONUs that transmits an optical signal next after the first ONU is started using the synchronization time acquired in the synchronization time acquisition step, and
a failure detection suppression step of causing a failure detection unit that detects a link failure with respect to the plurality of ONUs to suppress detection of a link failure by designating a period from the first time calculated in the first calculation step to the second time calculated in the second calculation step.

6. A communication control method in which a communication control device executes
a transmission time storage step of storing a transmission time of an optical signal with each of a plurality of ONUs,
a synchronization time acquisition step of acquiring a synchronization time from reception of an optical signal of each of the plurality of ONUs to end of synchronization processing,
an optical transmission control step of generating control information that is transmitted to the plurality of ONUs and controls transmission start and transmission end of an optical signal in each of the plurality of ONUs,
a first calculation step of calculating a first time at which reception of an optical signal from a first ONU among the plurality of ONUs ends using control information generated in the optical transmission control step for the first ONU and a transmission time with the first ONU stored in the transmission time storage step,
a second calculation step of calculating a second time at which synchronization processing ends after reception of an optical signal from a second ONU of the plurality of ONUs that transmits an optical signal next after the first ONU is started using the synchronization time acquired in the synchronization time acquisition step,
a suppression start step of causing a failure detection unit that detects a link failure with respect to the plurality of ONUs to start suppression of detection of a link failure from the first time calculated in the first calculation step, and
a suppression end step of causing the failure detection unit to end suppression of detection of a link failure at the second time calculated in the second calculation step.

7. A non-transitory computer-readable medium having computer-executable instructions that, upon execution of the instructions by a processor of a computer, cause the computer to function as communication control device according to claim 1.

8. (canceled)
